(19) United States
(12) Patent Application Publication
(10) Pub. No.: US 2024/0278209 A1
(43) Pub. Date: Aug. 22, 2024

(54) COMPOSITIONS AND METHODS FOR TOXIC SPECIES REMOVAL FROM FLUID

(71) Applicant: University of Maine System Board of Trustees, Orono, ME (US)

(72) Inventors: Islam Hafez, Orono, ME (US); Mehdi Tajvidi, Orono, ME (US); Md Musfiqur Rahman, Orono, ME (US); Aria Amirbahman, Orono, ME (US)

(21) Appl. No.: 18/569,419

(22) PCT Filed: Jun. 15, 2022
(86) PCT No.: PCT/US22/33621

§ 371 Date: Dec. 12, 2023

Related U.S. Application Data
(60) Provisional application No. 63/210,965, filed on Jun. 15, 2021.

(51) Int. Cl. B01J 20/24; B01J 20/28; B01J 20/32; C02F 1/28; C02F 101/10

(52) U.S. Cl. CPC B01J 20/24; B01J 20/28007; B01J 20/28028; B01J 20/28047; B01J 20/3236; B01J 20/3282; C02F 1/288; C02F 2101/103; C02F 2305/08; C02F 2307/14

(57) ABSTRACT

The present disclosure provides compositions for removing one or more toxic species, such as arsenic, one or more metalloids, or one or more other toxic elements and/or molecules, by, for example adsorption, methods of forming such compositions, and methods of using such compositions. In particular, in certain embodiments, a composition for removing one or more toxic species from a fluid (e.g., water) includes a cellulose-based matrix and a plurality of metal oxide particles dispersed throughout the matrix. The cellulose-based matrix may be a network and/or may be a cellulose fibril matrix, such as a cellulose nanofibril (CNF) matrix. The cellulose-based matrix may be an aerogel, for example a CNF aerogel. The metal oxide particles may be iron oxide particles, such as iron oxide nanoparticles. In some embodiments, a composition comprises metal oxide (e.g., iron oxide) particles (e.g., nanoparticles) dispersed in a cellulose fibril (e.g., CNF) aerogel matrix.

### CROSS-REFERENCE TO RELATED APPLICATION

The present application claims the benefit of U.S. Provisional Patent Application No. 63/210,965, filed on Jun. 15, 2021, the disclosure of which is hereby incorporated by reference herein in its entirety.

### BACKGROUND

Arsenic is one of the most toxic elements and can be found in ground water at high concentrations. According the Environmental Protection Agency (EPA) and World Health Organization (WHO), the limit of permissible arsenic concentration in water is 10 ppb. This low limit necessitates removing arsenic from water supplies in certain areas in order to make the water suitable for human use and/or consumption. Arsenic can be removed from water by reverse osmosis and ion exchange, among others. These technologies are efficient but they are often costly and are based on non-sustainable materials. There is a need, therefore, for compositions and methods for removing arsenic, and other toxic species, from water supplies that are simple and cost-effective.

### SUMMARY

Ongoing research on sustainable water treatment technology focuses largely on the scope of chemically functionalized nanocellulose based materials such as TEMPO (2,2,6,6-tetramethylpiperidine-1-oxyl) oxidized, carboxylated, phosphoryl, amino functionalized nanocellulose. Scientific reports have been published to prove the concept of nanocellulose based materials for a variety of water treatment process including removal of toxic chemicals, wastewater, dye and heavy metal. Even though previous works reported efficient nanocellulose based water treatment technologies, the complex production process involving the functionalization of nanocellulose hindered the technology to reach a large-scale application.

The present disclosure provides embodiments that solve problems with prior CNF approaches by using aerogel having particles dispersed throughout. Aerogel is a type of material which is derived from liquid suspension and eventually replaces the liquid component of that material by air. Freeze drying has been reported as a simple and effective technique to produce nanocellulose based aerogels. The functionalization of nanocellulose based aerogels has also been reported and applied for water treatment applications.

The incorporation of particles (e.g., nanoparticles) into nanocellulose matrix is a challenging task. According to the present disclosure, stable dispersions of particles in nanocellulose based matrices (e.g., aerogels) provides a solution to aggregation that has hindered previous application of particulate adsorbents and increases the large-scale applicability of the adsorbent. At present, the water filtration industries apply fixed bed column using the efficient packing materials based on activated carbon, alumina and organic ion exchange resin for removal of impurities such as dust, bacteria, aqueous salts and heavy metal ions. Nanocellulose based aerogels according to embodiments of the present disclosure can be a better alternative of those packing materials which are currently been used for arsenic removal.

The present disclosure provides, inter alia, compositions for removing one or more toxic species, such as arsenic, one or more metalloids, or one or more other toxic elements, by adsorption, methods of forming such compositions, and methods of using such compositions. In particular, in certain embodiments, a composition for removing one or more toxic species from a fluid, for example by adsorption, includes a cellulose-based matrix and a plurality of metal oxide particles dispersed throughout the matrix. The one or more toxic species may include one or more elements and/or one or more molecules, for example arsenic. The fluid may be water. The fluid may be a gas. The cellulose-based matrix may be a network and/or may be a cellulose fibril matrix, such as a cellulose nanofibril (CNF) matrix. The cellulose-based matrix may be an aerogel, for example a CNF aerogel. The metal oxide particles may be iron oxide particles, such as iron oxide nanoparticles (IONPs) (e.g., hematite and/or magnetite nanoparticles). Nano-size adsorbents, such as iron oxide nanoparticles have shown favorable performance towards toxic species removal, such as arsenic removal. In some embodiments, a composition comprises metal oxide (e.g., iron oxide) particles (e.g., nanoparticles) dispersed in a CNF aerogel matrix.

An amount of the one or more species in the fluid may be removed by flowing the fluid through the composition. In some embodiments, the amount of the one or more species is removed from the fluid by adsorbing onto the plurality of metal oxide particles dispersed in the matrix. Low density matrices, such as aerogels, can allow high fluid flow rates, can avoid introducing detrimental and/or disruptive pressure drops across the matrix, and/or can allow higher particle loadings.

A method for preparing a composition for removing one or more toxic species from a fluid may include providing metal oxide particles in a fluid mixture, adding cellulose fibrils, and then forming a cellulose-based matrix having the metal oxide particles dispersed throughout the matrix. In some embodiments, the metal oxide particles are formed by combining two or more precursor salts in a solvent and precipitating the product from the solution. In some embodiments, a base is added to promote precipitation. Energy, such as ultrasonication, may be applied after the precipitation to form nanoparticles from the precipitation product. In some embodiments, the resulting nanoparticles are amorphous (e.g., no more than 20% crystalline). A further heating step may be applied, for example to reduce the size of the particles.

In some aspects, the present disclosure is directed to a composition for removing (e.g., adsorbing) one or more toxic species (e.g., elements, molecules) from a fluid (e.g., water or a gas) includes a cellulose-based matrix (e.g., network) [e.g., a cellulose fibril matrix (e.g., a cellulose nanofibril (CNF) matrix] and a plurality of metal oxide particles dispersed throughout the matrix.

In certain embodiments, the matrix is an aerogel (e.g., having a porosity of at least 80%, e.g. at least 90%, and, optionally, no more than 99.999%) or a foam. In certain embodiments, the cellulose-based matrix has a porosity of at least 50% (e.g., at least 60%, at least 70%, at least 80%, or at least 90%). In certain embodiments, the matrix is a crosslinked cellulose fibril network (e.g., a crosslinked cellulose nanofibril network) (e.g., that is crosslinked with a resin, e.g. that is a water-soluble resin, e.g., a polyamide-based resin, such as a polyamide-epichlorohydrin).

In certain embodiments, the metal oxide particles are nanoparticles. In certain embodiments, the nanoparticles are substantially amorphous (e.g., no more than 20% crystalline, no more than 10% crystalline, or no more than 1% crystalline).

In certain embodiments, the metal oxide is an iron oxide (e.g., Fe₂O₃ or Fe₃O₄).

In certain embodiments, the metal oxide particles are doped (e.g., with an element from a precursor salt used to form the particles) [e.g., with an alkaline earth metal (e.g., magnesium)]. In certain embodiments, a concentration of dopant [e.g., an alkaline earth metal (e.g., magnesium)] in the metal oxide particles is from 1 at % to 15 at % (e.g., from 2 at % to 12 at %, from 4 at % to 10 at %, from 4 at % to 8 at %, or from 5 at % to 7 at %).

In certain embodiments, the composition comprises no agglomerates of the metal oxide particles having a dimension of larger than 2 microns (e.g., larger than 1 micron, larger than 500 nm).

In certain embodiments, a specific surface area of the particles is at least 75 m²/g (e.g., at least 100 m²/g, at least 125 m²/g, or at least 150 m²/g) and no more than 750 m²/g (e.g., no more than 500 m²/g, no more than 400 m²/g, no more than 300 m²/g, or no more than 250 m²/g). In certain embodiments, a specific surface area of the composition is at least 20 m²/g (e.g., at least 25 m²/g, or at least 30 m²/g) and no more than 150 m²/g (e.g., no more than 100 m²/g, no more than 75 m²/g, or no more than 50 m²/g). In certain embodiments, the composition has a water absorption capacity of at least 60 g/g (e.g., at least 70 g/g).

In certain embodiments, the composition has an isoelectric point at a pH of from 3.5 to 5.5 (e.g., from 4 to 5). In certain embodiments, the composition is stable in a pH range of at least from 6.5 to 7.5 (e.g., at about 7). In certain embodiments, the composition has a negative zeta potential in a range of at least from 4 to 10 (e.g., at least from 3 to 11).

In certain embodiments, the matrix and the metal oxide particles comprise surface hydroxyl groups.

In certain embodiments, the composition has a density of no more than 0.025 g/cm³ (e.g., no more than 0.02 g/cm³ or no more than 0.015 g/cm³). In certain embodiments, the composition is an aerogel or foam that has a shape recovery of at least 50% (e.g., at least 60% or at least 65%).

In certain embodiments, a concentration of the metal oxide particles in the matrix is at least 10 mg/L (e.g., at least 25 mg/L, at least 50 mg/L, or at least 60 mg/L). In certain embodiments, the particles are from 1 wt % to 25 wt % (e.g., from 5 wt % to 20 wt %) of the composition. In certain embodiments, the particles are from 10 wt % to 15 wt % of the composition. In certain embodiments, the particles are dispersed throughout the matrix such that an amount of no more than 20 μg (e.g., no more than 10 μg or no more than 5 μg) of the particles are leached per liter of fluid after a constant agitation over a period of at least 12 hours in the fluid.

In certain embodiments, the composition has a toxic species (e.g., element, e.g. arsenic) adsorption capacity (e.g., a toxic metalloid adsorption capacity) of at least 30 mg/g (e.g., at least 40 mg/g, at least 60 mg/g, at least 80 mg/g, or at least 90 mg/g) (e.g., has at least one of (i) an arsenic(III) adsorption capacity of at least 30 mg/g (e.g., at least 40 mg/g) and (ii) an arsenic(V) adsorption capacity of at least 80 mg/g (e.g., at least 90 mg/g)).

The composition may be comprised in a column (e.g., a continuous fixed-bed column). A fluid conduit may comprise the column, disposed in a fluid pathway through the conduit.

In some aspects, the present disclosure is directed to a method of removing one or more species (e.g., toxic element(s), toxic molecule(s)) from a fluid. The method may include providing a composition comprising a cellulose-based matrix and a plurality of metal oxide particles dispersed throughout the matrix and removing an amount of the one or more species (e.g., elements, molecules) from the fluid by flowing the fluid through the composition, for example by applying a fluid stream or soaking the composition and then removing fluid after the soak (e.g., by squeezing or otherwise applying pressure). In certain embodiments, the fluid is water [e.g., drinking water (e.g., well water)]. In certain embodiments, removing the amount of the one or more elements comprises adsorbing the amount of the one or more elements onto the particles. In certain embodiments, the one or more elements comprises one or both of arsenic(III) and arsenic(V). In certain embodiments, the removing reduces a concentration of the one or more elements by at least 50% (e.g., at least 60%, at least 75%, at least 80%, or at least 90%) (e.g., relative to a starting concentration of no more than 5 ppm). In certain embodiments, the fluid has a pH in a range of from 2 to 9 (e.g., from 6.5 to 8.5) (e.g., wherein the fluid has a pH of about 7). In certain embodiments, the composition is disposed in a pipe [e.g., of a building, e.g. a house or office, or a well (e.g., of a building)] (e.g., filling a cross section of the pipe) and flowing the fluid comprises flowing the fluid through the pipe (e.g., as caused by turning a faucet or spigot on). In certain embodiments, flowing the fluid through the composition results in leaching no more than 20 μg of the particles (e.g., no more than 10 μg or no more than 5 μg) from the composition per liter of the fluid (e.g., over a period of at least 12 hours).

In some aspects, the present disclosure is directed to a method of preparing a composition for removing (e.g., adsorbing) one or more toxic species (e.g., elements, molecules) (e.g., arsenic). The method may include providing metal oxide particles and cellulose fibrils (e.g., cellulose nanofibrils); adding the metal oxide particles and cellulose fibrils together in a fluid mixture (e.g., an aqueous solution) (e.g., by providing the metal oxide particles in a fluid mixture and adding the cellulose fibrils to the fluid mixture); and forming a cellulose-based matrix having the metal oxide particles dispersed throughout the matrix from the mixture.

In certain embodiments, the method includes adding a crosslinker (e.g., a water-soluble resin, e.g., a polyamide-based resin, such as a polyamide-epichlorohydrin) to the mixture, wherein forming the cellulose fibril matrix comprises crosslinking the cellulose fibrils with the crosslinker.

In certain embodiments, providing the metal oxide particles comprises: combining two or more precursor salts (e.g., at least one precursor comprising iron) (e.g., chlorides) in a solvent (e.g., ethanol) and precipitating a product from the solvent. A base may be added to the solvent prior to precipitation. The metal oxide particles may be formed from the product. In certain embodiments, the method further includes applying energy (e.g., ultrasonicating) to the product in the solvent (e.g., for at least 30 min or for at least one hour) to form the metal oxide particles (e.g., wherein the particles are nanoparticles) (e.g., wherein the metal oxide particles are doped with an element present in at least one of the two or more precursor salts). In certain embodiments, the method includes, after applying the energy, heating the particles in an oven (e.g., an autoclave) at a temperature of at least 100° C. (e.g., at least 125° C. or at least 150° C.) for at least one hour (e.g., at least two hours). In certain embodiments, the method includes reducing a size of the particles by subsequent heating (e.g., due to simultaneous nucleation and homogenous heating) (e.g., wherein the heating the particles in the oven is the subsequent heating). In certain embodiments, the method includes washing (e.g., by centrifugation) the particles until a mixture having a pH in a range of from 6 to 8 (e.g., from 6.5 to 7.5) is obtained. In certain embodiments, the adding of the cellulose fibrils occurs after the washing.

In certain embodiments, forming the cellulose fibril matrix with the particles dispersed throughout comprises freeze drying the mixture comprising the cellulose fibrils and the metal oxide particles (e.g. and the crosslinker). In certain embodiments, forming the cellulose fibril matrix with the particles comprises, after the freeze drying, heating the cellulose fibrils and the particles (e.g., and the crosslinker) (e.g., in a vacuum oven) to crosslink the cellulose fibrils.

Any two or more of the features described in this specification, including in this summary section, may be combined to form implementations not specifically explicitly described in this specification.

### BRIEF DESCRIPTION OF THE DRAWINGS

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1 illustrates a schematic of (i) an internal morphology of a CNF aerogel, without crosslinking and metal oxide particle immobilization in panel A, with crosslinking and without particle immobilization in panel B, with crosslinking and particle immobilization in panel C, and (ii) a photograph of a prepared cellulose nanofibril and iron oxide nanoparticle aerogel in panel D, according to illustrative embodiments of the present disclosure;

FIGS. 2A-2B illustrate methods of making a cellulose-based matrix with metal oxide particles dispersed therein, according to illustrative embodiments of the present disclosure;

FIG. 3 is a plot of XRD spectra of IONP, CNF, and CNF-IONP aerogels (where annotations in the parentheses indicate the miller indices of CNF), according to illustrative embodiments of the present disclosure;

FIG. 4 shows (i) scanning electron microscopy (SEM) images of CNF aerogels before (panels A, B, C) and after (panels D, E, F) IONP immobilization at different magnification and (ii) an SEM image (inset: EDAX spectra) (panel G) and corresponding EDS mapping (panel H) of CNF-IONP aerogel surface, according to illustrative embodiments of the present disclosure;

FIG. 5 is a plot of zeta potential measurements for CNF and IONP at different pH values with error bars representing standard deviation from triplet measurements, according to illustrative embodiments of the present disclosure;

FIG. 6 is a plot of Fourier transform infrared (FT-IR) spectrum of freeze dried IONP, crosslinked CNF and CNF-IONP aerogels stretching on CNF overlapped with N—H stretching originated for crosslinking, according to illustrative embodiments of the present disclosure;

FIG. 7 illustrates shape recovery and mass loss of CNF-IONP aerogels with variation of IONP content, according to illustrative embodiments of the present disclosure;

FIG. 8 shows plots of arsenic (III and V) adsorption kinetics of lab standard water samples with three different dosage of IONP in a CNF-IONP aerogel;

FIG. 9 illustrates the effect of pH on As(III) and As(V) adsorption of a CNF-IONP aerogel (panel A) (where error bars represent standard deviation from triplet experiments) and equilibrium adsorption isotherms of As(III) and As(V) for IONP in CNF-IONP aerogels (panel B), according to illustrative embodiments of the present disclosure; and

FIG. 10 illustrates As (V) adsorption with different wt % of IONP in a CNF-IONP aerogel (panel A) (where error bars represent standard deviation from triplet measurements) and SEM images of CNF-IONP (25 wt % loading) at different magnifications (panels B, C, D).

### DETAILED DESCRIPTION OF CERTAIN EMBODIMENTS

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included. In certain embodiments, the term “approximately” or “about” refers to a range of values that fall within 25%, 20%, 19%, 1⁸%, 7%1, 16%, 15%, 14%, 13%, 1², 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art. Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps. It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between. Headers are provided for the convenience of the reader and are not intended to be limiting with respect to the claimed subject matter.

The present disclosure provides, inter alia, compositions for removing toxic species, such as arsenic, by adsorption, methods of forming such compositions, and methods of using such compositions. In particular, in certain embodiments, a composition for removing one or more toxic species from a fluid, for example by adsorption, includes a cellulose-based matrix and a plurality of metal oxide particles dispersed throughout the matrix. The one or more toxic species may include one or more elements and/or one or more molecules, for example arsenic, ammonia, aluminum, barium, cadmium, chloramine, chromium, copper, lead, nitrates, nitrites, mercury, perchlorate, radium, selenium, silver, uranium, or some combination thereof. The fluid may be water, such as well water, drinking water, municipal water, or water from an aquifer, lake, stream, or river. The fluid may be a gas, such as air.

A cellulose-based matrix may be a network and/or may be a cellulose fibril matrix, such as a CNF matrix. A cellulose-based matrix may be porous. In some embodiments, a cellulose-based matrix has a porosity of at least 50% (e.g., at least 60%, at least 70%, at least 80%, or at least 90%). Preferred embodiments of a porous cellulose-based matrix include cellulose-based aerogels, for example CNF aerogels, and cellulose-based foams. An aerogel may have a porosity of, for example, at least 80%, at least 90%, at least 99%, at least 99.9%, at least 99.99%, or at least 99.999%. By using an aerogel (e.g., in combination with metal oxide in nanoparticle form), a composition may have a density of no more than 0.025 g/cm³ (e.g., no more than 0.02 g/cm³ or no more than 0.015 g/cm³). In some embodiments, a cellulose-based matrix is a crosslinked matrix where cellulose (e.g., cellulose fibrils) are crosslinked together, for example defining a network. For example, a cellulose-based matrix may be a crosslinked CNF network. A cellulose material of a matrix may be crosslinked with a crosslinker, such as a resin. In some embodiments, a crosslinker for a cellulose-based matrix is a water-soluble resin. In some embodiments, a crosslinker for a cellulose-based matrix is a polyamide-based crosslinker. The polyamide-based crosslinker may be a polyamide-based resin such as, for example, polyamide-epichlorohydrin. Polycup™ is a class of commercially available resins, including Polycup™ 5150, that are suitable for use in various embodiments of compositions disclosed herein. Use of crosslinked cellulose-based matrices may improve shape recovery thereby increasing the suitability of a composition for use in water filtration (e.g., making it more robust to handle higher fluid flow rates without detrimental deformation). In some embodiments, a composition (e.g., comprising metal oxide particles and a cellulose-based matrix) is an aerogel or foam that has a shape recovery of at least 50% (e.g., at least 60%, at least 65%, or at least 70%). In general, the chemical structure cellulose is a form of polysaccharide having a hierarchical chain connected with both β1-4 glycosidic bonds and hydrogen bonds among the units. In some embodiments, a diameter of fibrils in a cellulose-based matrix (e.g., CNF matrix) is between 5-50 nm. In some embodiments, a length of cellulose chains can be several micron (e.g., 2-10 microns).

Metal oxide particles dispersed in a cellulose-based matrix may be iron oxide particles, such as iron oxide nanoparticles (IONPs) (e.g., hematite and/or magnetite nanoparticles). Other non-iron metals may be used in a metal oxide particle, for example titanium, tin, zinc, and/or tungsten oxide particles may be used in various embodiments. A metal in a metal oxide particle may be a transition metal, such as iron. Metal oxide particles may be metal oxide nanoparticles. In some embodiments, metal oxide particles are from 1 wt % to 25 wt % (e.g., from 5 wt % to 20 wt %) of a composition. In some embodiments, metal oxide particles are from 10 wt % to 15 wt % of a composition. In some embodiments, a concentration of metal oxide particles in a cellulose-based matrix is at least 10 mg/L (e.g., at least 25 mg/L, at least 50 mg/L, or at least 60 mg/L). The particles may be dispersed throughout a matrix such that an amount of no more than 20 μg (e.g., no more than 10 μg or no more than 5 μg) of the particles are leached per liter of fluid after a constant agitation over a period of at least 12 hours in the fluid.

Conventionally, the high surface energy of oxide nanoparticles have a tendency of forming agglomerates and results in decreasing the specific surface area. However, with the aid of a cellulose-based matrix, aggregation of metal oxide particles can be decreased to a significant extent. Therefore, in some embodiments, a composition comprises no agglomerates of metal oxide particles having a dimension of larger than 2 microns (e.g., larger than 1 micron, larger than 500 nm). In some embodiments, a specific surface area of the particles is at least 75 m²/g (e.g., at least 100 m²/g, at least 125 m²/g, or at least 150 m²/g) and no more than 750 m²/g (e.g., no more than 500 m²/g, no more than 400 m²/g, no more than 300 m²/g, or no more than 250 m²/g). Because a cellulose-based matrix can also have a high specific surface area, in some embodiments, a specific surface area of a composition comprising metal oxide particles dispersed in a cellulose-based matrix is at least 20 m²/g (e.g., at least 25 m²/g, or at least 30 m²/g) and no more than 150 m²/g (e.g., no more than 100 m²/g, no more than 75 m²/g, or no more than 50 m²/g).

Particles dispersed in a cellulose-based matrix may be substantially amorphous. Amorphous particles are advantageous because they offer high surface area (e.g., than otherwise similar crystalline particles). However, without wishing to be bound by any particular theory, amorphous particles may be relatively unstable and therefore be at least partially converted to a crystalline form. Thus, an amorphous particle may include a small crystalline component (e.g., be less than 20%, less than 10%, less than 5%, or less than 1% crystalline). Moreover, doping amorphous particles may aid in maintaining their amorphousness (stabilize the particles) (e.g., for a longer period of time). In some embodiments, a metal oxide particle is doped. In some embodiments, the dopant is an element present in a precursor, such as a precursor salt, used to synthesize metal oxide particles. Examples of such elements include alkaline earth metals, such as magnesium. For example, iron oxide particles may be synthesized using iron chloride and magnesium chloride precursors (described further subsequently) resulting in magnesium doped iron oxide particles. Other dopant elements may be used. An iron oxide in iron oxide particles may be, for example hematite and/or magnetite (Fe₂O₃ and/or Fe₃O₄). A concentration of dopant in metal oxide particles may be from 1 at % to 15 at % (e.g., from 2 at % to 12 at %, from 4 at % to 10 at %, from 4 at % to 8 at %, or from 5 at % to 7 at %).

In some embodiments, a composition comprises metal oxide particles (e.g., iron oxide nanoparticles) dispersed in a cellulose-based matrix [e.g., a cellulose nanofibril matrix (e.g., aerogel)]. The composition may have an isoelectric point at a pH of from 3.5 to 5.5 (e.g., from 4 to 5). Alternatively or additionally, the composition may be stable in a pH range of at least from 6.5 to 7.5 (e.g., at about 7). Alternatively or additionally, the composition may have a negative zeta potential in a range of at least from 4 to 10 (e.g., at least from 3 to 11). In some embodiments, the matrix and the metal oxide particles comprise surface hydroxyl groups. Alternatively or additionally, the composition may have a water absorption capacity of at least 60 g/g (e.g., at least 70 g/g). Alternatively or additionally, the composition may have a toxic species (e.g., element, e.g. arsenic) adsorption capacity (e.g., a toxic metalloid adsorption capacity) of at least 30 mg/g (e.g., at least 40 mg/g, at least 60 mg/g, at least 80 mg/g, or at least 90 mg/g) (e.g., has at least one of (i) an arsenic(III) adsorption capacity of at least 30 mg/g (e.g., at least 40 mg/g) and (ii) an arsenic(V) adsorption capacity of at least 80 mg/g (e.g., at least 90 mg/g)).

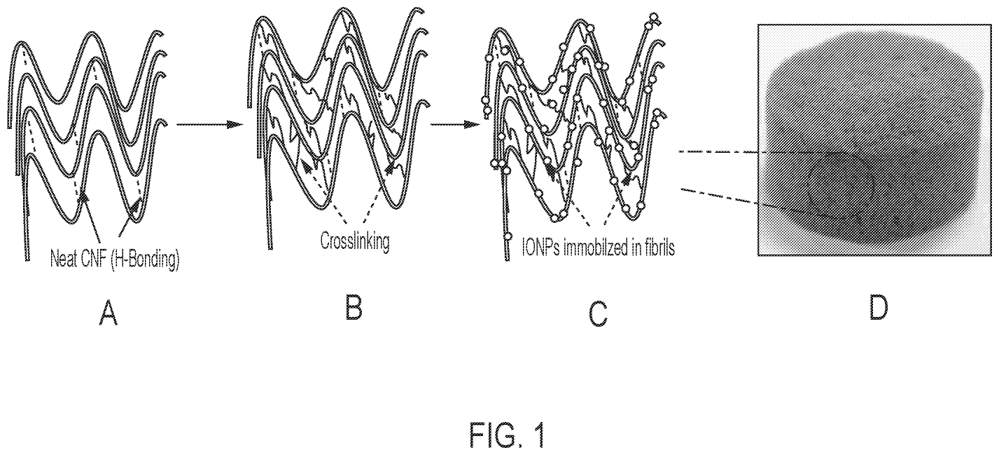

FIG. 1 shows an example of the relationship between structures of a cellulose-based matrix that is a CNF matrix (panel A), crosslinked CNF matrix (panel B), and iron oxide metal nanoparticles immobilized in a crosslinked CNF matrix (panel C), and a photograph of such an iron oxide metal nanoparticle crosslinked CNF matrix (panel D). As can be seen in panel D, the resulting structure of the composition can be highly porous, which facilitates water flow through the composition for toxic species removal. Packing nanoparticles in columns for commercial use is challenging. The present disclosure includes embodiments that solve this problem by dispersing particles (e.g., nanoparticles) throughout a matrix. In particular, according to the present disclosure, cellulose nanofibrils (CNF) have the potential to decrease the extent of NPs aggregations owing to its stable suspension. In such a case, drying a stable suspension of CNF/NPs into a foam or aerogel may result in uniformly distributed NPs within a CNF network. In some embodiments, a cellulose material and metal oxide particles are dried (e.g., freeze dried) into a foam or aerogel, which may result in a uniform distribution of the particles in a cellulose-based matrix formed of the cellulose material.

In some embodiments, a column (e.g., a continuous fixed-bed column) comprises a composition comprising metal oxide particles (e.g., metal oxide nanoparticles, such as iron oxide nanoparticles) dispersed in a cellulose-based matrix (e.g., a CNF matrix) (e.g., wherein the composition is an aerogel or foam). In some embodiments, a fluid conduit (e.g., pipe or tube) has such a column disposed in a fluid pathway through the conduit. A method of removing one or more species (e.g., toxic element(s), toxic molecule(s)) from a fluid may include providing such a matrix and removing an amount of the one or more species from the fluid by flowing the fluid through the composition. The fluid may be water [e.g., drinking water (e.g., well water)]. Removing the amount of the one or more elements may include adsorbing the amount of the one or more elements onto the particles. One or both of arsenic(III) and arsenic(V) may be removed, if present, from the fluid. In some embodiments, the one or more toxic species may include one or more elements and/or one or more molecules, for example arsenic, ammonia, aluminum, barium, cadmium, chloramine, chromium, copper, lead, nitrates, nitrites, mercury, perchlorate, radium, selenium, silver, uranium, one or more metalloids, or some combination thereof. A concentration of the one or more elements may be reduced by at least 50% (e.g., at least 60%, at least 75%, at least 80%, or at least 90%) (e.g., relative to a starting concentration of no more than 5 ppm). The fluid may have a pH in a range of from 2 to 9 (e.g., from 6.5 to 8.5) (e.g., wherein the fluid has a pH of about 7). Compositions disclosed herein can be used to remove one or more toxic species from a water supply or return, for example of a building, e.g. a house or office, or a well (e.g., of a building). Such removal can be accomplished by disposing a composition as disclosed herein in a fluid conduit (e.g., pipe), for example for a building, a house, an office, or a well. The composition may fill a cross section of a pipe. Flowing fluid through a composition may include, for example, flowing the fluid through a pipe (e.g., as caused by turning a faucet or spigot on) or soaking the composition in the fluid and then removing the fluid (e.g., by compressing (e.g., squeezing) the composition). In some embodiments, flowing a fluid through a composition results in leaching no more than 20 μg of particles (e.g., no more than 10 μg or no more than 5 μg) from the composition per liter of the fluid (e.g., over a period of at least 12 hours).

A method of preparing a composition for removing (e.g., adsorbing) one or more toxic species (e.g., elements, molecules) (e.g., arsenic) may include providing metal oxide particles and cellulose fibrils (e.g., cellulose nanofibrils); adding the metal oxide particles and cellulose fibrils together in a fluid mixture (e.g., an aqueous solution) (e.g., by providing the metal oxide particles in a fluid mixture and adding the cellulose fibrils to the fluid mixture); and forming a cellulose-based matrix having the metal oxide particles dispersed throughout the matrix from the mixture. A crosslinker may be added to the mixture in order to form a cross linked matrix. The crosslinker may be a water-soluble resin. The crosslinker may be a polyamide-based resin, such as a polyamide-epichlorohydrin. PolyCup™ is a suitable class of polyamide-epichlorohydrin crosslinkers for certain embodiments.

Metal oxide particles can be formed by combining two or more precursor salts (e.g., chlorides) in a solvent (e.g., ethanol). Where iron oxide particles are formed, at least one precursor would include iron. In some embodiments, a base may be added to the solvent. A product may then be precipitated from the solvent. The particles can be formed from the product. In some embodiments, a method further includes applying energy (e.g., ultrasonicating) to the product in the solvent (e.g., for at least 30 min or for at least one hour) to form the metal oxide particles (e.g., wherein the particles are nanoparticles). The metal oxide particles may be doped with an element present in at least one of the two or more precursor salts. Thus, metal oxide particle formation and doping may occur simultaneously, for example thereby ensuring a more even distribution of dopant throughout the particles.

In certain embodiments, a method of forming a composition may include, after applying the energy, heating the particles in an oven (e.g., an autoclave) at a temperature of at least 100° C. (e.g., at least 125° C. or at least 150° C.) for at least one hour (e.g., at least two hours). In certain embodiments, a size of the particles may be reduced by subsequent heating (e.g., due to simultaneous nucleation and homogenous heating) (e.g., wherein the heating the particles in the oven is the subsequent heating). In certain embodiments, the fluid mixture of the particles may then be washed (e.g., by centrifugation) until a mixture having a pH in a range of from 6 to 8 (e.g., from 6.5 to 7.5) is obtained. The cellulose fibrils may be added after washing.

In some embodiments, forming a cellulose-based matrix with the particles dispersed throughout comprises freeze drying a mixture comprising cellulose fibrils and metal oxide particles (e.g. and a crosslinker). In some embodiments, the cellulose fibrils and the particles (e.g., and the crosslinker) are heated (e.g., in a vacuum oven) after freeze drying to crosslink the cellulose fibrils. The resulting composition may be an aerogel or a foam.

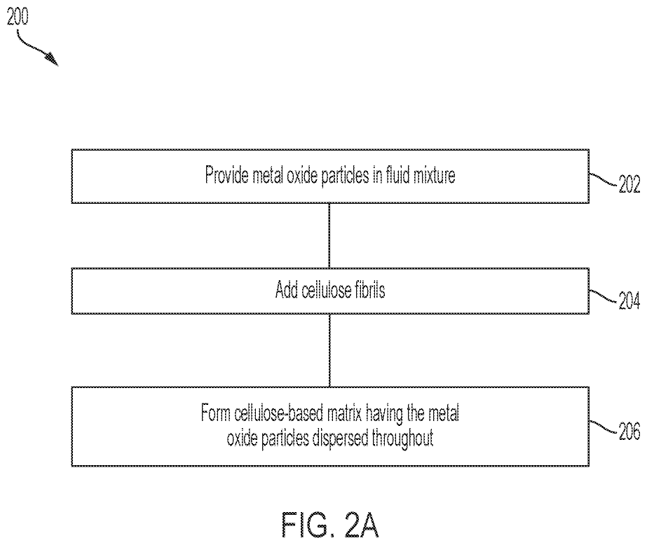

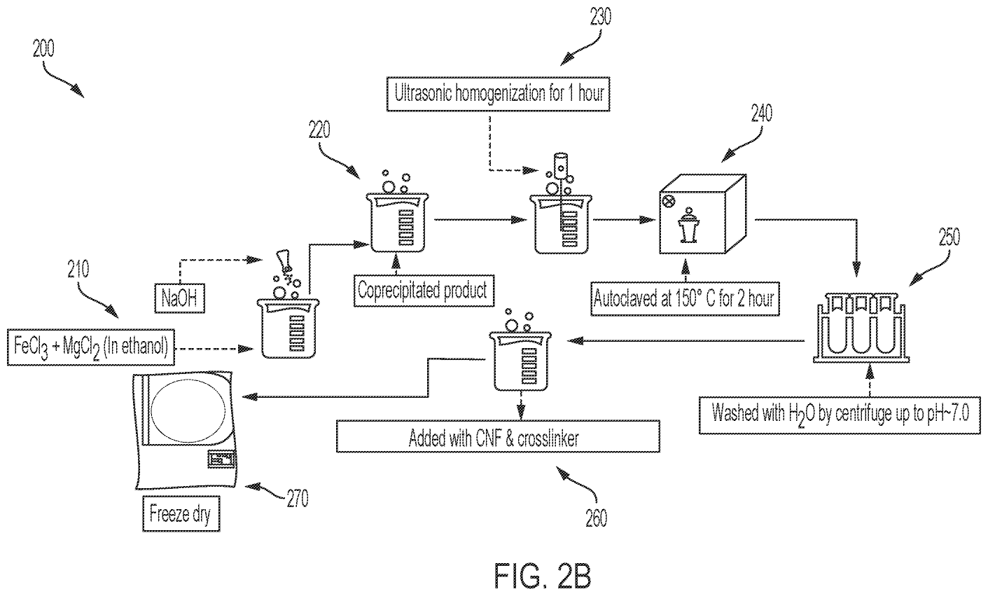

FIGS. 2A-2B illustrate exemplary methods of the present disclosure. In FIG. 2A, method 200 of forming a composition for removal of one or more toxic species from a fluid includes providing metal oxide particles in a fluid mixture in step 202, adding cellulose fibrils (e.g., nanofibrils) to the fluid mixture in step 204, and forming a cellulose-based matrix having the metal oxide particles dispersed throughout the matrix in step 206. In some embodiments, metal oxide particles are added to a fluid mixture that includes cellulose fibrils instead. FIG. 2B illustrates a detail process for method 200. In step 210, two precursors salts for metal oxide particles are added in a solvent, for example FeCl₃ and MgCl₂ in ethanol. A base, such as NaOH, may also be added in step 210. A product is co-precipitated in step 220. Energy is applied to the product for a period of time in step 230, for example ultrasonic homogenization for a period of at least one hour. The particles can be autoclaved (e.g., at 150° C. for 2 hours) in step 240. They can then be washed, for example with water and centrifugation, in step 250. Such washing may be used to alter the pH of the mixture in which the particles are dispersed, for example to a neutral pH (of about 7). Steps 210-250 may be performed to perform step 202. In step 260, cellulose nanofibrils and crosslinker may be added, for example to perform step 204. In step 270, the mixture of CNF and crosslinker and metal oxide particles from step 250 may be freeze dried to form a cellulose-based matrix having the metal oxide particles dispersed throughout (perform step 206). Forming a cellulose-based matrix having metal oxide particles dispersed throughout the matrix (step 206) may also include heating the freeze dried composition in order to promote crosslinking.

### EXAMPLES

In order that the application may be more fully understood, the following examples are set forth. It should be understood that these examples are for illustrative purposes only and are not to be construed as limiting in any manner.

In certain embodiments, a novel amorphous iron oxide nanoparticles (IONP) based cellulose nanofibrils (CNF) aerogel (CNF-IONP) has been developed for arsenic removal from drinking water. The IONP was doped with magnesium Mg and synthesized by a room temperature co-precipitation followed by a solvent thermal synthesis method. The CNF and IONPs were combined with the aid of crosslinker and freeze dried to get highly porous composite aerogel. Scanning electron microscopy (SEM) and energy dispersive spectroscopy (EDS) showed the evenly dispersed IONP in CNF fibrils. The specific surface area of IONP was found 165 m²/g where specific surface area of IONP incorporated CNF aerogel adsorbent was calculated as 32 m²/g which is higher than crosslinked CNF aerogel (12 m²/g). X-ray diffraction (XRD), Fourier transform infrared (FT-IR), and Zeta potential measurements were also conducted for evaluating the properties of the CNF-IONP aerogel adsorbent. The shape recovery, mass loss upon drying, porosity and density of crosslinked CNF-IONP aerogel were investigated and compared with crosslinked CNF aerogel. The adsorption kinetics indicates that both arsenic (III) and (V) follow a pseudo-second-order kinetic model where the adsorption process is highly dependent on pH. The equilibrium adsorption isotherm was best fitted into Langmuir model for both arsenic (III) and (V). The maximum adsorption capacity for arsenic (III) and (V) was found as 48 and 91 mg/g of IONP in CNF-IONP aerogel. The ˜12.5% IONP to CNF-IONP ratio was found as the most efficient approach for the CNF-IONP aerogel with minimal leaching of iron in water.

### Materials

Cellulose nanofibrils (CNF) were obtained from the Process Development Centre (PDC) of University of Maine. The 3% w/w CNF was produced from mechanically refined wood pulp at the University of Maine's Process Development Center (PDC). This CNF was diluted with distilled water to make a 1% weight by weight (w/w) to further use throughout the experiments. Polycup™ 5150 crosslinker (26% w/w) was obtained from Solenis (Wilmington, DE, USA). Anhydrous ferric chloride (98%) and magnesium chloride (99%) were purchased from Alfa Aeser (Massachusetts, USA). Anhydrous ethyl alcohol (99.5%) was obtained from Acros Organics (New Jersey, USA). HEPES buffering agent (>99.5%), sodium chloride (>99%), sodium hydroxide (>97%) and hydrochloric acid (37%), sodium (meta) arsenite, and sodium arsenate dibasic heptahydrate (>98%) were purchased from Sigma-Aldrich. All the chemicals and solvents were used without any further purification.

### Synthesis of Mg-Doped Hydrous Iron Oxide Nanoparticles (IONPs)

The synthesis procedure of the Mg-doped hydrous iron oxide nanoparticles (IONPs) was adapted from the previous work of Tang et al., Superparamagnetic magnesium ferrite nanoadsorbent for effective arsenic (III, V) removal and easy magnetic separation, Water Research, 47(11): 3624-3634 (2013), the disclosure of which is hereby incorporated by reference herein in its entirety. At first step, 0.09 M FeCl₃ and 0.01 M of MgCl₂ were prepared by dissolving the appropriate amount of both salts in 70 mL of ethanol. A 10 mL of 2.3 M ethanolic sodium hydroxide solution was added to the salt mixture.

The red-yellowish precipitation of amorphous Mg-doped ferric hydroxide (Fe, Mg)ₓ(OH)_{y} was obtained and subsequently ultrasonicated (Branson 450, VWR Scientific) to convert it to nano sized particles. The reaction mixture was then transferred to a 100 mL Teflon-lined autoclave and placed in a preheated oven at 150° C. for 2 hours. During this heating process, the simultaneous nucleation and homogeneous heating made the particle size smaller. The hydrous IONP were washed with distilled water using a high-speed centrifuge (Sorvall R6 Plus, RCF of 31,916) until a pH of 7 was obtained. During the washing, the ethanol was removed and the NaCl was dissolved. Finally, an adequate amount of water was added to make a suspension of the IONP and then the suspension was subsequently stored at 35-40° F.

### Preparation of IONPs Immobilized in a CNF Aerogel (CNF-IONP) Adsorbent

At first, a batch of 1% w/w CNF was added with 5% w/w Polycup™ crosslinker (based on the dry mass of the CNF). The mixture was stirred with magnetic stirrer at 300 rpm for 5 minutes to ensure homogeneous distribution of crosslinker throughout the CNF suspension. The optimum quantity of IONP suspension was added to maintain a 12.5% dry mass of IONPs on a CNF-IONP suspension mixture. The suspension mixture was mechanically stirred with a magnetic stirrer followed by ultrasonic homogenization for 5 minutes each. Finally, the CNF-IONP suspension mixture was poured in cylindrical plastic molds for the subsequent freeze drying in a Harvest Right freeze-dryer (North Salt Lake, Utah, USA). The temperature cycles of the freeze dryer were maintained as −34.4, −6.7, 4.4, 15.6, and 32.2° C. for 6, 10, 8, 3 and 3 h, respectively. After freeze-drying, the CNF-IONP aerogel adsorbents were heated in a vacuum oven (25 mm Hg=86 kPa) at 105±2° C. to induce crosslinking. FIG. 1 is a schematic representation of surface morphology of CNF aerogel before and after crosslinking followed by IONP incorporation.

### Characterization

A Panalytical X'Pert PRO diffractometer (Royston, UK) was used to analyze the crystallinity of freeze-dried IONPs and CNF aerogels individually as well as CNF-IONP aerogel adsorbents to verify modification of CNF after IONP incorporation. The XRD anode material was Cu with K_{α} at a wavelength of 1.54 nm. The generator voltage and current were 40 kV and 40 mA, respectively. The scan step size and 20 range was 0.05°/sec and 10-80° subsequently. The baseline correction, smoothing, and background subtraction for the XRD data was performed by using Origin Pro 2021 software.

The surface morphology of CNF aerogel before and after IONP immobilization was assessed by a Zeiss NVision 40 (CA, USA) scanning electron microscope (SEM). The aerogel samples for SEM were prepared by slicing through the middle section by a sharp blade. Prior to imaging, all samples were sputter coated with gold-palladium at an accelerating voltage of 3 kV.

An iXRF model 550i EDS system (AMRay 1820, CA, USA) was used for elemental mapping of iron, magnesium, carbon, and oxygen on the surface of CNF-IONPs. An accelerating voltage of 20 kV was maintained for the EDS analysis.

The specific surface area (SSA) of freeze-dried CNF aerogel and IONP were measured by BET (Brunauer, Emmett and Teller) N₂ adsorption method using an ASAP 2020 instrument (Micromeritics, GA, USA). The IONP sample was degassed in vacuum at 130° C. for five hours. CNF aerogel sample was degassed at 75° C. for the same duration. The specific surface area of CNF-IONP aerogel was estimated mathematically based on the % of IONP and CNF present in CNF-IONP aerogel.

The ATR-FTIR was performed using a PerkinElmer Spectrum Two™ FT-IR spectrophotometer (MA, USA) to evaluate the nature of the interaction between the CNF and IONP in the aerogel. The data obtained for CNF and CNF-IONP aerogels were normalized with respect to wavenumber 1055 cm⁻¹ which represents the stretching vibration of the cellulose backbone (not altered by the crosslinking reaction).

Malvern Nano ZS90 Zetasizer (Malvern Instruments Ltd., Malvern, Worcestershire, UK) was used to measure the zeta potential of CNF and IONP in water. The iso-electric point (IEP) for both CNF and IONP were extrapolated by measuring zeta potential over a wide range of pH (2-11).

The density, ρ (g cm⁻³), and porosity (%) of the cylindrical aerogels were calculated by measuring the void volume (v₁) by Accupyc II gas pycnometry system (Micrometrics, GA, USA) and the total volume v₂ using a digital caliper and corresponding mass (m) using Equation 1 and 2 respectively.

$$Density of the aerogel , ρ = \frac{m}{ν 2} \qquad ( 1 )$$

$$Porosity ( \% ) = ( 1 - \frac{v 1}{v 2} ) \times 100 \qquad ( 2 )$$

The shape recovery was conducted by pressing the aerogel at a pressure of 1.2 kPa using a Dake® manual hydraulic pump. The aerogel formed into a thin sheet (˜5 mm) and submerged into 50 mL water for 10 seconds. The aerogel height before compression (hᵢ) and after submerging into the water for 10 s (h_{f}) was recorded. The shape recovery was calculated by using Equation 3.

$$Shape recovery ( \% ) = \frac{{h}_{f}}{{h}_{i}} \times 100 \qquad ( 3 )$$

The water absorption capacity of the aerogels was determined by calculating the mass differences of aerogels before (wᵢ) and after (w_{f}) soaked into 50 mL of distilled water for 10 seconds. The unit of this parameter was calculated as (g g⁻¹) using Equation 4.

$$Water absorption capacity ( g {g}^{- 1} ) = \frac{( {W}_{{f}^{-}} {W}_{i} )}{{W}_{i}} \qquad ( 4 )$$

The mass loss for CNF and CNF-IONP aerogels were determined gravimetrically by submerging the aerogels into 50 mL of water for 10 s and drying in an oven at 75° C. for 5 h. By comparing the initial (m₁) and after drying (m₂) dry mass, the % of mass loss was calculated using Equation 5.

$$Mass loss ( \% ) = ( \frac{{m}_{f} - {m}_{i}}{{m}_{i}} ) \times 100 \qquad ( 5 )$$

### Batch Arsenic Adsorption Experiments

All batch arsenic adsorption experiments were carried out at room temperature (˜25° C.) by constant agitation of solution using VWR Scientific Products rocking platform Model 100 (Radnor, PA, USA). The equilibrium contact time for all experiments was set as 12 hr, which was selected after several initial trials. All trace metal ion concentration in water was measured by Thermo Scientific™ Element 2™ ICP-MS (MA, USA) calibrated using SLRS-6, a river certified reference material from National Research Council of Canada. The arsenic concentration for kinetics modeling was maintained as ˜300 μg/L for both As(III) and As(V) which is relatively higher than the arsenic concentration which can be found in natural river water between low to middle range. For isotherm modeling, a wide range of arsenic concentration was chosen for both arsenic species. Both kinetics and isotherm experiments were done by using 10 mM HEPES buffer of pH 7.0 with a fixed ionic strength of 0.05 M NaCl.

### X-Ray Diffraction Analysis, Surface Morphology and Elemental Composition

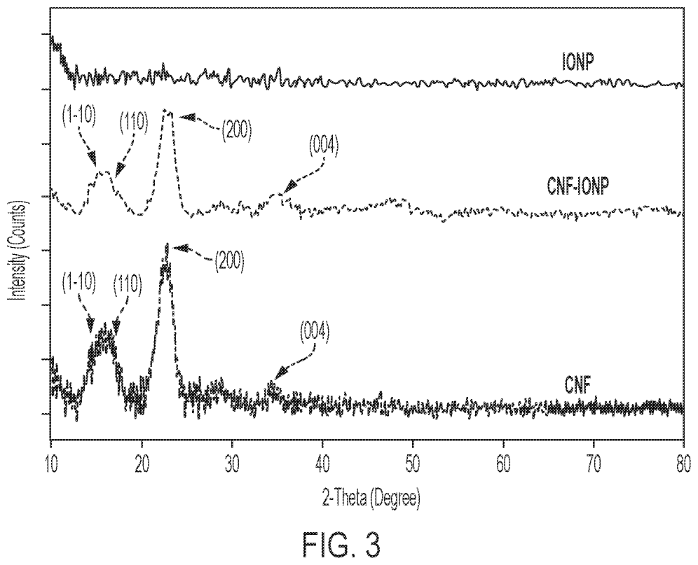

FIG. 3 presents the comparative XRD patterns for freeze-dried IONP, CNF-IONP aerogel, and CNF aerogel. The XRD spectra of IONP showed a featureless characteristic without showing any visual peak, indicating amorphousness. It is known from previous studies that amorphous IONPs have a high surface area with metastable nature—having a high tendency to convert into crystalline IONP over the time and temperature. Conversion into crystalline IONP decreases the specific surface area significantly, which, without wishing to be bound by any particular theory, lowers the overall efficiency of the system (e.g., CNF-IONP adsorbent). Doping the IONP with another metal ion will likely avoid the situation by both retaining the amorphous nature of IONP with impeding the increment of crystallinity. The XRD spectrum for IONP is also in accordance with previous studies made on amorphous iron oxides and hydroxides.

The XRD pattern of both CNF and CNF-IONP aerogels have shown similar kind of nature by exhibiting the distinguishable peaks for CNF. The broad spectra between 15-16.5° corresponds to Miller indices (1-10) and (110). The sharp peak around 22.5° corresponds to the lattice diffraction of (200) plane. The low intensity peak around 350 corresponds to plane of (004) for presence of cellulose I. However, the noticeable decrease was observed in peak intensity for cellulose in CNF-IONP aerogel due to the incorporation of amorphous IONP. Without wishing to be bound by any particular theory, presence of amorphous IONP is likely to disrupt the hydrogen bonding among the cellulose nanofibrils resulting in decreasing the peak intensity for cellulose.

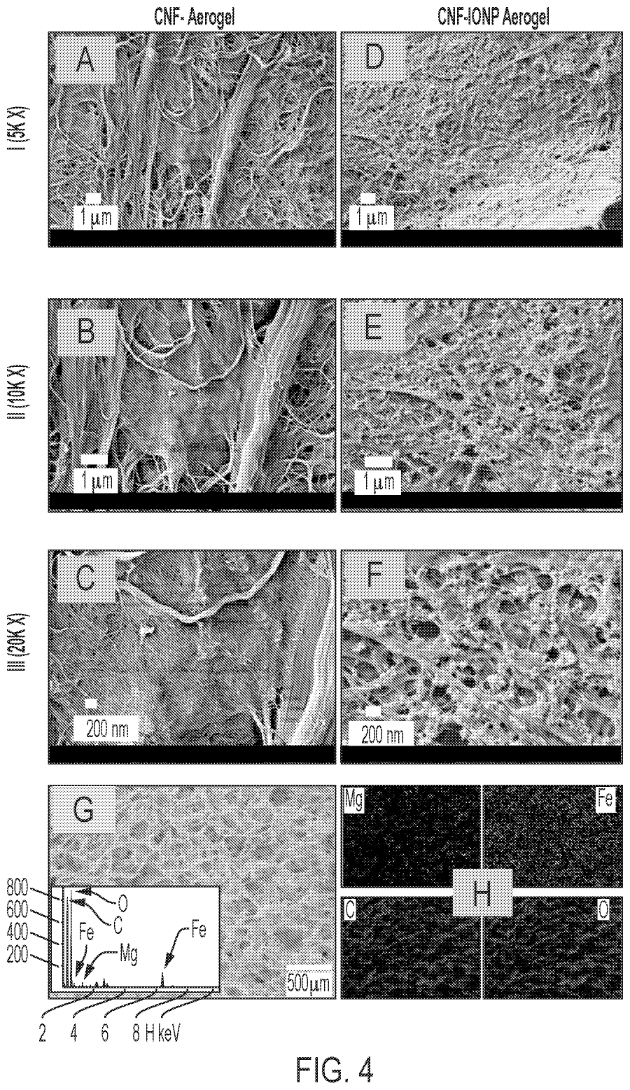

Scanning electron microscopy (SEM) was performed to observe the morphological fate of the crosslinked CNF surface after the incorporation of IONPs. The smaller number of hanging fibrils on CNF aerogel indicates the effect of crosslinking prior to the addition of IONPs (FIG. 4 panels A, B, C). Conventionally, the high surface energy of oxide nanoparticles have a tendency of forming agglomerates and results in decreasing the specific surface area. However, with the aid of CNF, the aggregation of IONP has been decreased to a significant extent (e.g., no agglomerate is larger than ˜200-500 nm) (FIG. 4 panels D, E, F). Without wishing to be bound by any particular theory, this may happen by mechanical attachment of smaller IONP clusters with CNF in suspension form and, which are then trapped inside nanoscale void space of aerogels and/or foams after freeze drying.

To get further insights of CNF-IONP aerogel surface, EDS mapping was conducted (FIG. 4 panels G, H). The elemental composition of IONPs on CNF shows the uniform distribution of Fe and Mg on CNF. The atomic % of Mg and Fe was found as ˜0.45 and ˜6.48 which suggest Mg was ˜6.5% compared to Fe on IONP which is a slightly higher than what is, in some embodiments, a desired value (6.1%). Additionally, the elemental composition of C and O in CNF-IONP surface was found as ˜ 41% and 52%, respectively.

### Evaluation of Specific Surface Area, Porosity, Zeta Potential and Infra-Red Spectroscopy

Although BET specific surface area of crosslinked CNF aerogel was very low, ˜13 m²/g, a high specific surface area of 165 m²/g for freeze dried IONP was observed which is higher than other conventional iron oxides. However, it has been reported in a previous study that the 2-line ferrihydrite, a type of amorphous IONP, can have a very high surface area of ˜530-710 m²/g while kept in wet state. Although amorphous IONP has high surface area, the stability is a big drawback as it tends to crystallize and transform itself into more stable phase and decreases the surface area to high extent. To solve this problem, Mg was used as dopant which increases the stability of the amorphous IONP significantly by inhibiting it transforming into more stable crystalline goethite and hematite. It is also an well-established fact that due to the closeness of ionic radii, Mg²⁺ co-precipitates and incorporates itself deep into the crystal structure of Fe³⁺ which results in thermodynamically stabilized IONP by decreasing the surface free energy.

The specific surface area of CNF-IONP aerogel was calculated mathematically as 32 m²/g based on the % weight of IONP and CNF in the material (Table 1, values inside the parentheses stands for the standard deviation from triplet measurements). Also, the average porosity of the CNF and CNF-IONP aerogel was estimated as 98% and 95%, respectively (Table 1).

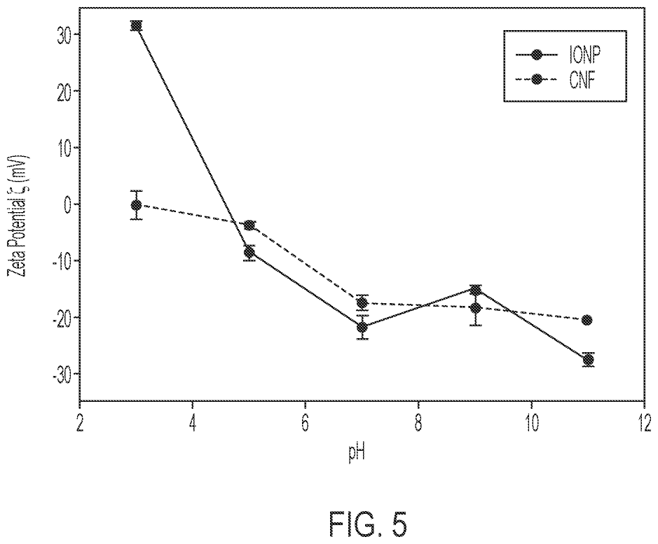

FIG. 5 presents zeta potential measurements for both CNF and IONP suspension at a pH of about 2-12. A negative zeta potential at a pH of 7 indicates the presence of surface hydroxyl group on both. The observed negative zeta potential of CNF within a wide range of pH (3-11). A low isoelectric point (IEP) at pH˜4.6 was observed for IONP which indicates the high applicability towards arsenic ion adsorption. Without wishing to be bound by any particular theory, the reason behind the low IEP for doped IONPs compared to the conventional IONP can be explained in terms of high Mg doping on IONPs. Without wishing to be bound by any particular theory, due to the presence of negatively charged surface hydroxyl group on both CNF and IONP surfaces, the chemical interaction between CNF and IONPs seems to be unlikely which has been observed by forming a stable suspension, e.g. at pH˜7.

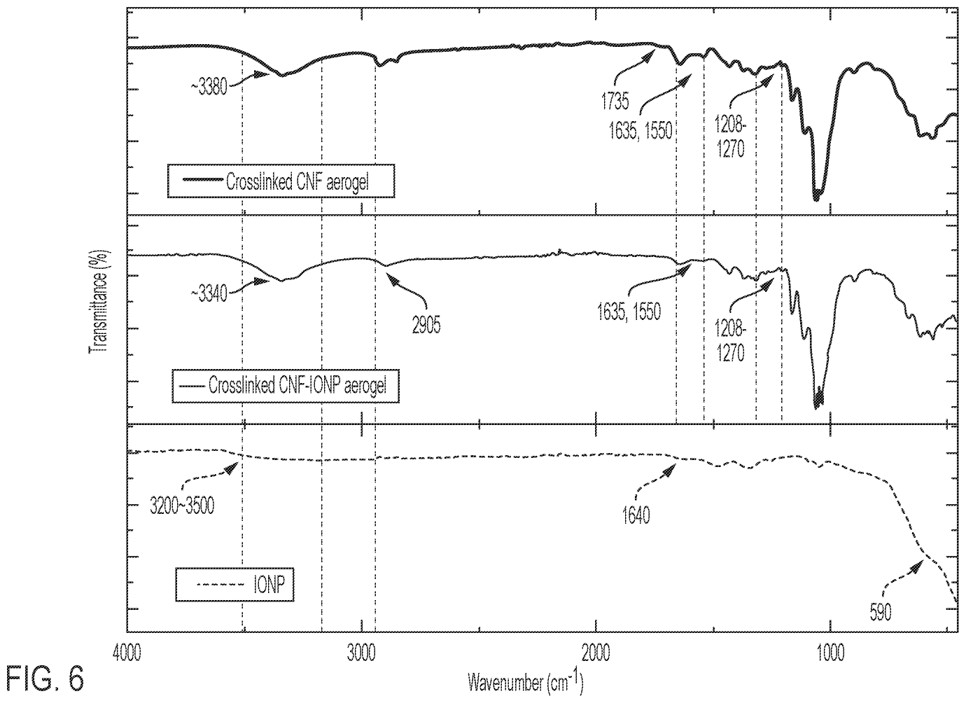

To further investigate the interaction between crosslinked CNF and IONP, FT-IR was performed (FIG. 6). For IONP, an absorption peak was observed at ˜590 cm⁻¹ which is attributed to Fe—O band vibration (Battisha et al., 2006; Lassoued et al., 2017). A broad absorption peak at 3200˜3500 cm⁻¹ and a small one at ˜1640 cm⁻¹ was observed due to the stretching and bending vibrations for —OH group. On the other hand, both crosslinked CNF and CNF-IONP aerogel exhibited almost similar characteristics. A broad absorption peak at ˜3340 cm⁻¹ is attributed to inter and intra molecular —OH.

FIG. 5: The absorption band at 2905 cm⁻¹ corresponds to the aliphatic C—H stretching. The amide-I (C═O) and H—OH bending vibrations both contributes for the peak at 1635 cm⁻¹ while amide-II (N—H) corresponds to the peak at 1550 cm⁻¹. In addition, the broad peak between 1208-1270 ascribed for C—O stretching vibration for ester bonds for crosslinker. Although, the CNF-IONP aerogel showed excellent stability in water aided by the crosslinker; no characteristic peak ˜1735 cm⁻¹ was observed which attributes to C═O stretching vibration for ester group. However, this peak was observed in crosslinked CNF aerogels which can be disrupted by the presence of higher fraction of IONP with CNF.

### Comparison on Water Absorption Capacity, Density, Shape Recovery and Mass Loss Between Crosslinked CNF and CNF-IONP Aerogel

To explore the change of hydrophilicity of the porous crosslinked CNF-IONP aerogel, the water absorption capacity was measured. The average water absorption capacity for crosslinked CNF aerogel was found as 96.5 g/g which was almost the same as a previously reported study. The opulence of surface hydroxyl group on CNF attributes to its high hydrophilicity. Contrarily, the crosslinked CNF-IONP aerogel showed a comparatively smaller value of 74.9 g/g which could result due to the decrease of the CNF component of the aerogel. Due to the presence of IONP in CNF pores it might be possible to decrease the overall water absorption capacity of CNF-IONP aerogel. Furthermore, the higher average density for crosslinked CNF-IONP aerogel (0.013 g/cm³ vs. 0.009 g/cm³) was found compared to crosslinked CNF aerogel which also validates the correlation between water absorption capacity and porosity of the both type of aerogels (Table 1).

TABLE 1

| | Water | | | | | Specific |
|---|---|---|---|---|---|---|
| | Absorption | | Shape | Mass | | Surface |
| | Capacity | Density | Recovery | loss | Porosity | Area |
| Sample | (g/g) | (g/cm³) | (%) | (%) | (%) | (m²/g) |
| CNF | 96.5 | 0.009 | 83.9 | 2.6 | 98 | 13 |
| Aerogel | (4.9) | (0.01) | (2.4) | (0.7) | | |
| CNF- | 74.9 | 0.013 | 69.8 | 3.2 | 95 | 32 |
| IONP | (2.6) | (0.03) | (1.7) | (1.0) | | |
| Aerogel | | | | | | |

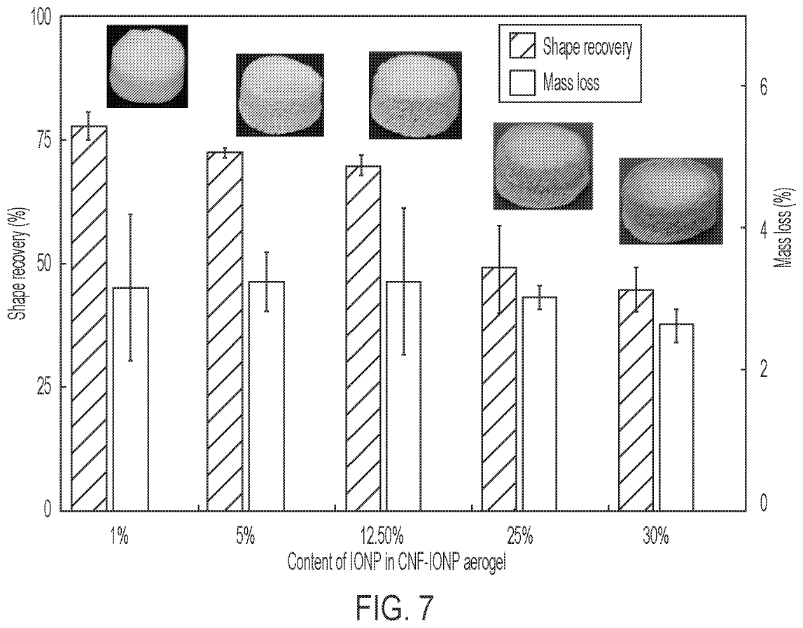

The shape recovery of un-crosslinked CNF may be poor especially in wet state which may make it unsuitable for application in water. Without wishing to be bound by any particular theory, the intramolecular hydrogen bonds along with molecular formation in CNF fibrils are believed to get disrupted by water molecules which indicates that CNF itself is not strong enough for its structural stability in water. However, in any case, polyamide-epichlorohydrin resin shows promising results by significantly enhancing stability and flexibility of CNF in water. Crosslinked CNF-aerogel does not show any shape fixation property after compression in normal condition but when it gets in contact with water, the high surface tension of water creates large capillary force by confining the fibrils together. By diffusion of water into the pores with partial swelling of amorphous cellulose, the fibrils get expanded. Although the dry mass of crosslinked CNF is unaltered in CNF-IONP aerogel, the presence of ˜12.5% IONP has been observed to destabilize the expansion of certain samples of aerogel by lowering their average shape recovery to 74.9%. It has also been observed that the higher fraction of the IONP results in a decreasing trend of shape recovery for crosslinked CNF-IONP aerogel (FIG. 7).

The mass loss of aerogels can also depict the stability of that material in wet condition which was observed gravimetrically. The average mass loss of crosslinked CNF-IONP aerogel was observed between 2.6˜3.3% regardless the fraction of IONP in aerogel (FIG. 7). Interestingly, it was also observed that the higher the fraction of IONP, the average mass loss of crosslinked CNF-IONP aerogel is minimum. The results suggests that the material is highly stable in wet condition and the leaching of iron oxide is very unlikely which will be confirmed in subsequent description.

### Arsenic Adsorption Kinetics on CNF-IONP Aerogel

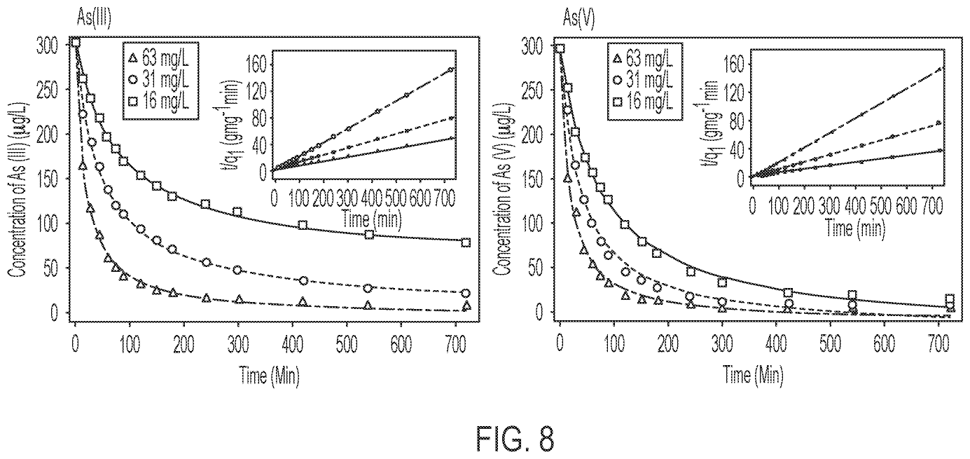

FIG. 8 represents the adsorption kinetics of As(III) and As(V) at different dosage in CNF-IONP aerogel. CNF itself cannot remove arsenic from water. It functions as an ideal carrier for IONPs by dispersing IONPs homogeneously on (e.g., crosslinked) nanofibrils of cellulose. Depending on dosage of IONP in the aerogels, the adsorption kinetics were quantified. It has clearly been observed that arsenic concentration of water decreased over time and reached up to a plateau at equilibrium time of 12 hour. It has also been noticed that the rate of removal was faster in first 3 hours regardless the dosage of adsorbent. By combining both experiments, it can be concluded that with just 63 mg/L IONP adsorbent in a CNF-IONP aerogel, both As(III) and As(V) concentrations get down under 10 μg/L from ˜300 μg/L with more than 97% removal efficiency without any pretreatment or pH adjustment. The post adsorption pH of the arsenic solution also did not experience any noticeable change.

Data obtained from experimental kinetic results could be best fitted into a pseudo-second-order kinetic model which is an extensively used model for adsorption of heavy metal ions, dye or organic contaminants on various adsorbents. This pseudo-second-order rate equation can be described as Equation 6:

$$\frac{t}{{q}_{t}} = \frac{t}{{q}_{e}} + \frac{1}{{K}_{a d} {q}_{e}^{2}} \qquad ( 6 )$$

where qₑ and qₜ are the amount of arsenic adsorbed (mg/g) on adsorbent (IONP) at equilibrium and at time t, respectively, K_{ad} denotes the rate constant for pseudo-second order kinetic equation (g/mg. min). The experimental data of both As(III) and As(V) adsorption fitted accurately with the pseudo-second-order kinetic model which can be concluded by the closeness of square of correlation coefficient (r²) to 1. The pseudo-second-order rate constant (K_{ad}) for both As(III) and As(V) increased progressively with increasing the dosage of adsorbent. The pseudo-second-order rate constant (K_{ad}) for both As(III) and As(V) shown an increasing trend with the increase of adsorbent. Comparing the results of both arsenic species, it was observed that the rate of removal for As(V) was higher than As(III) with the same dosage of adsorbent. These results indicate that there might be a rate limiting step involved in the adsorption process where the arsenic is chemically adsorbed on to iron oxide nanoparticles by covalent bonding. The adsorption kinetics results are summarized in Table 2.

TABLE 2

| Adsorbent | IONP in CNF-IONP aerogel | | | | | |
|---|---|---|---|---|---|---|
| Arsenic Species | As(III) | | | As(V) | | |
| Initial As | 0.0296 | | | 0.0302 | | |
| Concentration (mg/L) | | | | | | |
| Materials Loading | 16 | 31 | 63 | 16 | 31 | 63 |
| (mg/L) | | | | | | |
| qₑ (mg/g) | 15.42 | 9.61 | 4.89 | 20.08 | 10.25 | 4.88 |
| K_{ad} (g/(mg · min)) | 0.0008 | 0.0021 | 0.012 | 0.00066 | 0.0026 | 0.012 |
| r² | 0.99 | 0.99 | 0.99 | 0.99 | 0.99 | 0.99 |

### Effect of pH on Arsenic Adsorption Efficiency of CNF-IONP Aerogel

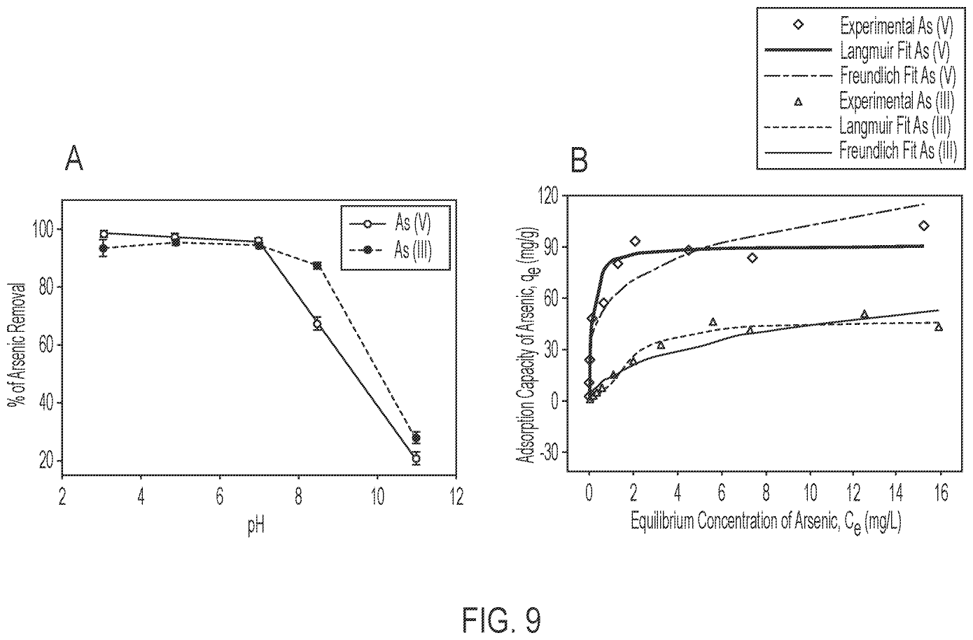

To investigate the pH dependency of both As(III) and As(V) adsorption on CNF-IONP aerogel, a set of experiments were performed. An initial concentration of 1 ppm arsenic solution was used with a fixed IONP dosage of ˜63 mg/L in CNF-IONP aerogel. Depending upon the pH of water, As(III) can exist as, for example, H₃AsO₃, H₂AsO₃⁻, HAsO₃²⁻, and AsO₃³⁻ whereas different forms of arsenic (V) are, for example, H₃AsO₄, H₂AsO₄⁻, HAsO₄²⁻, and AsO₄³⁻. FIG. 9, panel A, shows a high removal was achieved (>93%) for both arsenic species within acidic to neutral pH (3-7) indicating the electrostatic attraction between positively charged iron hydroxide and arsenic anionic species. However, at pH much beyond 7, the arsenic adsorption was decreased significantly which can be explained by the surface electrostatic repulsion between deprotonated surface OH⁻ groups of iron oxide and anionic arsenic species. Interestingly, at higher pH, As(V) adsorption experienced a higher decrease which may be due to the considerably high electrical charge of As(V) compared to As(III). Although the pH of safe drinking water lies in between 6.5 and 8.5, the sources of ideal drinking water usually have pH close to 7. Considering this situation, it is expected that, in certain embodiments, a CNF-IONP aerogel has excellent adsorption efficiency for both As(III) and As(V).

### Equilibrium Adsorption Isotherm Modeling of As(III) and As(V) on IONP in CNF-IONP Aerogel

The maximum arsenic adsorption capacity of IONP in crosslinked CNF-IONP aerogel at neutral pH˜7.0 was investigated by equilibrium adsorption isotherm study. Experimental data for both As(III) and As(V) were fitted into Langmuir and Freundlich model. FIG. 9, panel B, demonstrates the equilibrium adsorption isotherm plots for both As(III) and As(V). The Langmuir model is applicable for monolayer formation assuming the surface is homogeneous where the Freundlich model is an empirical one which considers the possibility of multilayer adsorption. The Langmuir and Freundlich adsorption isotherm are denoted by Eq. 7 and 8 respectively.

$${q}_{e} = \frac{{q}_{max} {K}_{L} {C}_{e}}{\frac{1}{{K}_{L} {C}_{e}}} \qquad ( 7 )$$

where qₑ is the amount (mg/g) of As(III) or As(V) adsorbed at equilibrium, qₘ is the maximum adsorption capability (mg/g) of IONPs in CNF-IONP aerogel, Cₑ is the equilibrium As(III) or As(V) concentration (mg/L) in post adsorption water samples, and K_{L} is the Langmuir constant of adsorption.

$${q}_{e} = {{K}_{F} ( {C}_{e} )}^{\frac{1}{n}} \qquad ( 8 )$$

where qₑ is the amount (mg/g) of As(III) or As(V) adsorbed at equilibrium, Cₑ is the equilibrium concentration (mg/L) of As(III) or As(V) in post adsorption water samples, K_{F} and n are the Freundlich constants of adsorption.

Both As(III) and As(V) adsorption could be best fitted into Langmuir adsorption model with closeness of the correlation coefficient, r²=0.99 which is summarized in Table 3. The maximum adsorption capacities of IONP in CNF-IONP aerogel for As(III) and As(V) were calculated as 47.75 mg/g and 90.90 mg/g respectively.

Although the adsorption isotherm experiments were performed within a wide concentration range, the natural water does not usually contain that high concentration of arsenic. So, the adsorption of arsenic at lower concentration is more important than adsorption at high concentration. The IONP in CNF-IONP aerogel showed significantly higher affinity at low concentration range of 0.055 mg/L-0.350 mg/L for As(III) and 0.073 mg/L-0.287 mg/L for As(V). In addition, the isotherm data reveals the higher arsenic (III & V) adsorption for IONP at low equilibrium concentration than high equilibrium concentration which could be attributed by surface charge disparities of arsenic species at neutral pH. The equilibrium adsorption isotherm studies for adsorption of As(III) and As(V) by CNF-IONP aerogel at pH˜7 are summarized on Table 3.

TABLE 3

| Arsenic species | As(III) | | As(V) | |
|---|---|---|---|---|
| Fitting isotherm | Langmuir | | Langmuir | |
| | qₘₐₓ (mg/g) | 47.75 | qₘₐₓ (mg/g) | 90.90 |
| | r² | 0.99 | r² | 0.99 |
| | K_{ads} | 2.36 | K_{ads} | 7.95 |

Correlation Between Arsenic Adsorption and IONP Content in CNF-IONP Aerogel and Leaching of Fe from CNF-IONP Aerogel

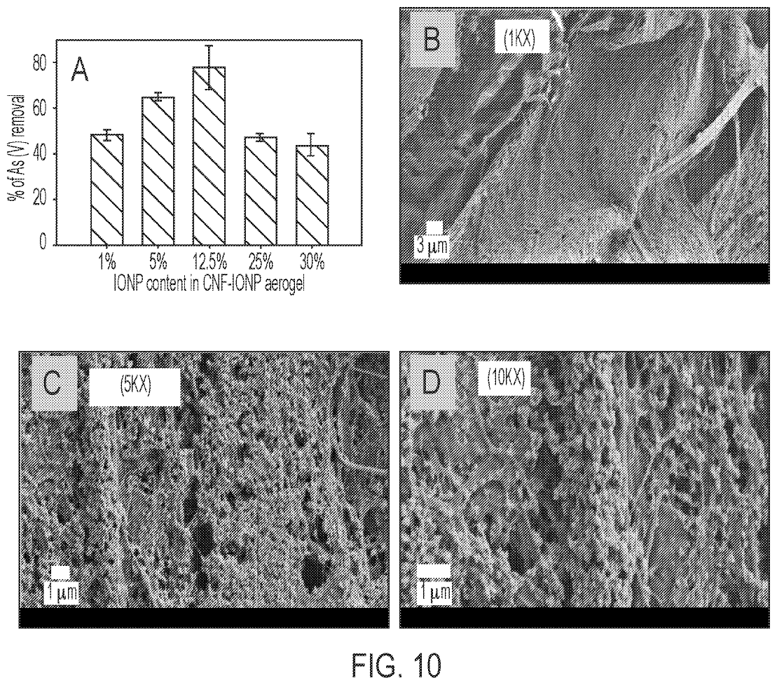

FIG. 10 presents the correlation of As(V) adsorption with different content of IONP in CNF-IONP aerogel. The dry mass of CNF for each type of aerogel was fixed by varying the wt % of IONP between 1 and 30%. A relatively high concentration of 7.2 mg/L of As(V) solution was used to perform the analysis with 12 hours of constant agitation in contact with adsorbent. It was observed that the increase of IONP content from 1 to 12.5%, the average As(V) removal increased linearly. The highest average adsorption efficiency of ˜78% was observed for 12.5 wt % of IONP in a CNF-IONP aerogel. Increasing the IONP content beyond 12.5% dropped the efficiency of As(V) removal significantly which may happen due to the excessive amount of IONP blocking the nanopores of CNF by decreasing the number of active sites for arsenic adsorption. The SEM images for CNF-IONP (25%) at different magnification has shown in FIG. 10 (panels B, C and D). The images show the IONP agglomeration increased significantly after 12.5% which is evident for lowering the adsorption efficiency. The same trend for As(III) adsorption is expected which can be inferred from these results. The excessive amount of IONP may cause difficulties for diffusion process by unsaturation of the adsorption sites of IONP in CNF matrix which may decrease the arsenic adsorption efficiency to a high extent. A one-way ANOVA statistical test was run to evaluate the statistical significance among the group. The results indicate that the 5% and 12.5% IONP content in CNF-IONP performs statistically significant arsenic removal with P=1 (P>0.05) where the rest of three IONP content did not show any statistically significance in terms of arsenic removal (P=0.034). This concludes that an optimum CNF to IONP ratio exists, in certain embodiments, while designing this composite material for arsenic adsorption. However, the IONP loading of ˜12.5% has shown excellent adsorption efficiency without any mechanical deformation, which suggests there is no need to increase the IONP content in certain embodiments of a CNF-IONP aerogel. Also, the increase of IONP beyond a certain level may increase the change of IONP leaching in water.

The leaching of IONP from CNF-IONP aerogel was measured by measuring the total Fe content of post adsorption water samples. The result shows—with 12.5% of IONP in CNF-IONP aerogel, a very insignificant amount <10 μg/L of IONP was leached after a constant agitation of 12 hours period which is well below than WHO and US-EPA MCL limit of 300 μg/L for safe drinking water.

In summary, example embodiments of a highly porous CNF-IONP aerogel were prepared by incorporating IONP in CNF by simultaneous freeze drying. The amorphous IONPs were synthesized by a room temperature co-precipitation reaction followed by a solvent thermal method which had a high BET specific surface area of 165 m²/g. A ˜12.5% w/w of IONPs in CNF-IONP aerogel was optimized for the best adsorption efficiency towards arsenic removal under certain conditions (other conditions may have different optimized IONP concentrations). Scanning electron microscopy and elemental analysis confirmed the uniform distribution of IONP in CNF surface. Mechanical stability of the material was confirmed by the analysis of shape recovery and mass loss upon drying. Both arsenic (III) and (V) were observed to follow a pseudo second order kinetic model where the maximum adsorption capacity was determined by Langmuir adsorption isotherm modelling as 48 mg and 91 mg/g of IONP in CNF-IONP aerogel. Such compositions can be a potential alternative for existing arsenic removal filtration system for large scale applications.

### ENUMERATED EMBODIMENTS

The following enumerated embodiments are expressly contemplated within the scope of the present disclosure. These enumerated embodiments are illustrative and are not intended to be limiting or exhaustive.

1. A composition for removing (e.g., adsorbing) one or more toxic species (e.g., elements, molecules) from a fluid (e.g., water or a gas), the composition comprising a cellulose-based matrix (e.g., network) [e.g., a cellulose fibril matrix (e.g., a cellulose nanofibril (CNF) matrix]; and a plurality of metal oxide particles dispersed throughout the matrix.

2. A composition for adsorbing one or more toxic species (e.g., elements, molecules) from a fluid (e.g., water or a gas), the composition comprising a cellulose-based matrix (e.g., network) [e.g., a cellulose fibril matrix (e.g., a cellulose nanofibril (CNF) matrix]; and a plurality of metal oxide particles dispersed throughout the matrix.

3. A composition for adsorbing one or more elements and/or molecules from a fluid (e.g., water or a gas), the composition comprising a cellulose-based matrix (e.g., network) [e.g., a cellulose fibril matrix (e.g., a cellulose nanofibril (CNF) matrix]; and a plurality of metal oxide particles dispersed throughout the matrix.

4. A composition for adsorbing one or more elements and/or molecules from water, the composition comprising a cellulose-based matrix (e.g., network) [e.g., a cellulose fibril matrix (e.g., a cellulose nanofibril (CNF) matrix]; and a plurality of metal oxide particles dispersed throughout the matrix.

5. A composition for adsorbing one or more elements and/or molecules from water, the composition comprising a cellulose-based network [e.g., a cellulose fibril matrix (e.g., a cellulose nanofibril (CNF) matrix]; and a plurality of metal oxide particles dispersed throughout the matrix.

6. A composition for adsorbing one or more elements and/or molecules from water, the composition comprising a cellulose fibril matrix (e.g., a cellulose nanofibril (CNF) matrix); and a plurality of metal oxide particles dispersed throughout the matrix.

7. A composition for adsorbing one or more elements and/or molecules from water, the composition comprising a cellulose nanofibril (CNF) matrix; and a plurality of metal oxide particles dispersed throughout the matrix.

8. A composition for adsorbing one or more elements and/or molecules from water, the composition comprising a cellulose fibril matrix (e.g., a cellulose nanofibril (CNF) matrix); and a plurality of transition-metal oxide particles dispersed throughout the matrix.

9. A composition for adsorbing one or more elements and/or molecules from water, the composition comprising a cellulose nanofibril (CNF) matrix; and a plurality of transition-metal oxide particles dispersed throughout the matrix.

10. A composition for adsorbing one or more elements and/or molecules from water, the composition comprising a crosslinked cellulose fibril matrix (e.g., a cellulose nanofibril (CNF) matrix); and a plurality of metal oxide particles dispersed throughout the matrix.

11. A composition for adsorbing one or more elements and/or molecules from water, the composition comprising a crosslinked cellulose nanofibril (CNF) matrix; and a plurality of metal oxide particles dispersed throughout the matrix.

The particles in any of embodiments 1-11 may be nanoparticles. The metal oxide particles any of embodiments 1-11 may be iron oxide particles. The metal oxide particles in any of embodiments 1-11 may be iron oxide nanoparticles (e.g., comprising Fe₂O₃ and/or Fe₃O₄). The particles in any of embodiments 1-11 may be substantially amorphous (e.g., no more than 20% crystalline, no more than 10% crystalline, or no more than 1% crystalline). The particles in any of embodiments 1-11 may be doped, for example with an alkaline earth metal, such as magnesium. A concentration of the dopant may be from 1 at % to 15 at % (e.g., from 2 at % to 12 at %, from 4 at % to 10 at %, from 4 at % to 8 at %, or from 5 at % to 7 at %). In any of embodiments 1-11, the particles may be from 1 wt % to 25 wt % of the composition (e.g., from 10 wt % to 15 wt %). The composition of any of embodiments 1-11 may have a porosity of at least 50%. The composition of any of embodiments 1-11 may be an aerogel or foam, for example where the cellulose-based matrix [e.g., cellulose fibril matrix (e.g., CNF matrix)] (e.g., network) is an aerogel or foam and the metal oxide particles are dispersed throughout that aerogel or foam. The matrix of the composition of any of embodiments 1-11 may be a crosslinked matrix. For example, the cellulose fibril matrix of embodiment 10 (i) may be crosslinked with a resin, (ii) may be crosslinked with a water-soluble crosslinker (e.g., resin), and/or (iii) may be crosslinked with a polyamide-based crosslinker (e.g., resin), such as a polyamide-epichlorohydrin. As another example, the cellulose nanofibril matrix of embodiment 11 (i) may be crosslinked with a resin, (ii) may be crosslinked with a water-soluble crosslinker (e.g., resin), and/or (iii) may be crosslinked with a polyamide-based crosslinker (e.g., resin), such as a polyamide-epichlorohydrin. The composition of any of embodiments 1-11 may have a density of no more than 0.025 g/cm³ (e.g., no more than 0.02 g/cm³ or no more than 0.015 g/cm³).

### EQUIVALENTS AND SCOPE

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

What is claimed is:

1. A composition for removing (e.g., adsorbing) one or more toxic species (e.g., elements, molecules) from a fluid (e.g., water or a gas), the composition comprising:
a cellulose-based matrix (e.g., network) [e.g., a cellulose fibril matrix (e.g., a cellulose nanofibril (CNF) matrix]; and
a plurality of metal oxide particles dispersed throughout the matrix.

2. The composition of claim 1, wherein the matrix is an aerogel (e.g., having a porosity of at least 80%, e.g. at least 90%, and, optionally, no more than 99.999%) or a foam.

3. The composition of claim 1 or claim 2, wherein the cellulose-based matrix has a porosity of at least 50% (e.g., at least 60%, at least 70%, at least 80%, or at least 90%).

4. The composition of any one of claims 1-3, wherein the metal oxide particles are nanoparticles.

5. The composition of claim 4, wherein the nanoparticles are substantially amorphous (e.g., no more than 20% crystalline, no more than 10% crystalline, or no more than 1% crystalline).

6. The composition of any one of claims 1-5, wherein the metal oxide is an iron oxide (e.g., Fe₂O₃ or Fe₃O₄).

7. The composition of any one of claims 1-6, wherein the metal oxide particles are doped (e.g., with an element from a precursor salt used to form the particles) [e.g., with an alkaline earth metal (e.g., magnesium)].

8. The composition of claim 7, wherein a concentration of dopant [e.g., an alkaline earth metal (e.g., magnesium)] in the metal oxide particles is from 1 at % to 15 at % (e.g., from 2 at % to 12 at %, from 4 at % to 10 at %, from 4 at % to 8 at %, or from 5 at % to 7 at %).

9. The composition of any one of claims 1-8, wherein the composition comprises no agglomerates of the metal oxide particles having a dimension of larger than 2 microns (e.g., larger than 1 micron, larger than 500 nm).

10. The composition of any one of claims 1-9, wherein the matrix is crosslinked (e.g., with a resin, e.g. that is a water-soluble resin, e.g., a polyamide-based resin, such as a polyamide-epichlorohydrin).

11. The composition of any one of claims 1-10, wherein the matrix is a crosslinked cellulose fibril network (e.g., a crosslinked cellulose nanofibril network) (e.g., that is crosslinked with a resin, e.g. that is a water-soluble resin, e.g., a polyamide-based resin, such as a polyamide-epichlorohydrin).

12. The composition of any one of claims 1-11, wherein a specific surface area of the particles is at least 75 m²/g (e.g., at least 100 m²/g, at least 125 m²/g, or at least 150 m²/g) and no more than 750 m²/g (e.g., no more than 500 m²/g, no more than 400 m²/g, no more than 300 m²/g, or no more than 250 m²/g).

13. The composition of any one of claims 1-12, wherein a specific surface area of the composition is at least 20 m²/g (e.g., at least 25 m²/g, or at least 30 m²/g) and no more than 150 m²/g (e.g., no more than 100 m²/g, no more than 75 m²/g, or no more than 50 m²/g).

14. The composition of any one of claims 1-13, wherein the composition has an isoelectric point at a pH of from 3.5 to 5.5 (e.g., from 4 to 5).

15. The composition of any one of claims 1-14, wherein the composition is stable in a pH range of at least from 6.5 to 7.5 (e.g., at about 7).

16. The composition of any one of claims 1-15, wherein the composition has a negative zeta potential in a range of at least from 4 to 10 (e.g., at least from 3 to 11).

17. The composition of any one of claims 1-16, wherein both the matrix and the metal oxide particles comprise surface hydroxyl groups.

18. The composition of any one of claims 1-17, wherein the composition has a water absorption capacity of at least 60 g/g (e.g., at least 70 g/g).

19. The composition of any one of claims 1-18, wherein the composition has a density of no more than 0.025 g/cm³ (e.g., no more than 0.02 g/cm³ or no more than 0.015 g/cm³).

20. The composition of any one of claims 1-19, wherein the composition is an aerogel or foam that has a shape recovery of at least 50% (e.g., at least 60% or at least 65%).

21. The composition of any one of claims 1-20, wherein a concentration of the metal oxide particles in the matrix is at least 10 mg/L (e.g., at least 25 mg/L, at least 50 mg/L, or at least 60 mg/L).

22. The composition of any one of claims 1-21, wherein the particles are from 1 wt % to 25 wt % (e.g., from 5 wt % to 20 wt %) of the composition.

23. The composition of claim 22, wherein the particles are from 10 wt % to 15 wt % of the composition.

24. The composition of any one of claims 1-23, wherein the particles are dispersed throughout the matrix such that an amount of no more than 20 μg (e.g., no more than 10 μg or no more than 5 μg) of the particles are leached per liter of fluid after a constant agitation over a period of at least 12 hours in the fluid.

25. The composition of any one of claims 1-24, wherein the composition has a toxic species (e.g., element, e.g. arsenic) adsorption capacity (e.g., a toxic metalloid adsorption capacity) of at least 30 mg/g (e.g., at least 40 mg/g, at least 60 mg/g, at least 80 mg/g, or at least 90 mg/g) (e.g., has at least one of (i) an arsenic(III) adsorption capacity of at least 30 mg/g (e.g., at least 40 mg/g) and (ii) an arsenic(V) adsorption capacity of at least 80 mg/g (e.g., at least 90 mg/g)).

26. A column (e.g., a continuous fixed-bed column) comprising the composition of any one of claims 1-25.

27. Fluid conduit comprising the column of claim 26 disposed in a fluid pathway through the conduit.

28. A pipe having the composition of any one of claims 1-25 disposed therein such that the composition fills a cross section of the pipe [e.g., through which the fluid (e.g., water) is flowed].

29. A method of removing one or more species (e.g., toxic element(s), toxic molecule(s)) from a fluid, the method comprising:
providing a composition comprising a cellulose-based matrix and a plurality of metal oxide particles dispersed throughout the matrix; and
removing an amount of the one or more species (e.g., elements, molecules) from the fluid by flowing the fluid through the composition.

30. The method of claim 29, wherein the fluid is water [e.g., drinking water (e.g., well water)].

31. The method of claim 29, wherein the fluid is a gas.

32. The method of any one of claims 29-31, wherein removing the amount of the one or more elements comprises adsorbing the amount of the one or more elements onto the particles.

33. The method of any one of claims 29-32, wherein the one or more elements comprises one or both of arsenic(III) and arsenic(V).

34. The method of any one of claims 29-33, wherein the removing reduces a concentration of the one or more elements by at least 50% (e.g., at least 60%, at least 75%, at least 80%, or at least 90%) (e.g., relative to a starting concentration of no more than 5 ppm).

35. The method of any one of claims 29-34, wherein the fluid has a pH in a range of from 2 to 9 (e.g., from 6.5 to 8.5) (e.g., wherein the fluid has a pH of about 7).

36. The method of any one of claims 29-35, wherein the composition is disposed in a pipe [e.g., of a building, e.g. a house or office, or a well (e.g., of a building)] (e.g., filling a cross section of the pipe) and flowing the fluid comprises flowing the fluid through the pipe (e.g., as caused by turning a faucet or spigot on).

37. The method of any one of claims 29-36, wherein flowing the fluid through the composition results in leaching no more than 20 μg of the particles (e.g., no more than 10 μg or no more than 5 μg) from the composition per liter of the fluid (e.g., over a period of at least 12 hours).

38. The method of any one of claims 29-37, wherein the composition is one according to any one of claims 1-25.

39. A method of preparing a composition for removing (e.g., adsorbing) one or more toxic species (e.g., elements, molecules) (e.g., arsenic), the method comprising:
providing metal oxide particles and cellulose fibrils (e.g., cellulose nanofibrils);
adding the metal oxide particles and the cellulose fibrils together in a fluid mixture (e.g., an aqueous solution) (e.g., by providing the metal oxide particles in a fluid mixture and adding the cellulose fibrils to the fluid mixture); and
forming a cellulose-based matrix having the metal oxide particles dispersed throughout the matrix from the mixture.

40. The method of claim 39, comprising adding a crosslinker (e.g., a water-soluble resin, e.g., a polyamide-based resin, such as a polyamide-epichlorohydrin) to the mixture, wherein forming the cellulose-based matrix comprises crosslinking the cellulose fibrils with the crosslinker.

41. The method of claim 39 or claim 40, wherein providing the metal oxide particles comprises:
combining two or more precursor salts (e.g., at least one precursor comprising iron) (e.g., chlorides) in a solvent (e.g., ethanol);
adding a base to the solvent; and
precipitating a product from the solvent.

42. The method of claim 41, further comprising applying energy (e.g., ultrasonicating) to the product in the solvent (e.g., for at least 30 min or for at least one hour) to form the metal oxide particles (e.g., wherein the particles are nanoparticles) (e.g., wherein the metal oxide particles are doped with an element present in at least one of the two or more precursor salts).

43. The method of claim 42, comprising, after applying the energy, heating the particles in an oven (e.g., an autoclave) at a temperature of at least 100° C. (e.g., at least 125° C. or at least 150° C.) for at least one hour (e.g., at least two hours).

44. The method of claim 42 or claim 43, comprising reducing a size of the particles by subsequent heating (e.g., due to simultaneous nucleation and homogenous heating) (e.g., wherein the heating the particles in the oven is the subsequent heating).

45. The method of any one of claims 42-44, comprising washing (e.g., by centrifugation) the particles until a mixture having a pH in a range of from 6 to 8 (e.g., from 6.5 to 7.5) is obtained.

46. The method of claim 45, wherein the adding of the cellulose fibrils occurs after the washing.

47. The method of any one of claims 39-46, wherein forming the cellulose-based matrix with the particles dispersed throughout comprises freeze drying the mixture comprising the cellulose fibrils and the metal oxide particles (e.g. and the crosslinker).

48. The method of claim 47, wherein forming the cellulose-based matrix with the particles comprises, after the freeze drying, heating the cellulose fibrils and the particles (e.g., and the crosslinker) (e.g., in a vacuum oven) to crosslink the cellulose fibrils.

49. The method of any one of claims 39-48, wherein a composition comprises the cellulose-based matrix and the metal oxide particles and the composition is one according to any one of claims 1-23.

50. A composition made by a method according to any one of claims 39-48.

51. A method of preparing a composition for removing (e.g., adsorbing) one or more toxic species (e.g., elements, molecules) (e.g., arsenic), the method comprising:
providing metal oxide particles and cellulose (e.g., cellulose fibrils, e.g., cellulose nanofibrils);
adding the metal oxide particles and the cellulose together in a fluid mixture (e.g., an aqueous solution) (e.g., by providing the metal oxide particles in a fluid mixture and adding the cellulose to the fluid mixture); and
forming a cellulose-based matrix having the metal oxide particles dispersed throughout the matrix from the mixture.
